(19) United States
(12) Patent Application Publication
(10) Pub. No.: US 2025/0219542 A1
(43) Pub. Date: Jul. 3, 2025

(54) MULTI-PHASE VOLTAGE REGULATOR CIRCUIT AND CURRENT BALANCING CIRCUIT

(71) Applicant: PowerX Semiconductor Corporation, Hsinchu County (TW)

(72) Inventors: Yueh Lung KUO, Hsinchu County (TW); Chia-Hung TSEN, Hsinchu County (TW)

(21) Appl. No.: 18/766,676

(22) Filed: Jul. 9, 2024

(30) Foreign Application Priority Data
Dec. 28, 2023 (TW) 112151458

(51) Int. Cl. H02M 3/158

(52) U.S. Cl. CPC H02M 3/1584

(57) ABSTRACT

A multi-phase voltage regulator circuit applied in a multi-phase power converter is provided. The multi-phase voltage regulator circuit comprises multiple comparison circuits. The comparison circuits are coupled to a power output stage circuit and configured to generate multiple control signals The power output stage circuit generates multiple output currents according to the control signals. Each of the comparison circuits comprises a comparator and a correction conversion circuit. The comparator is configured to receive a compensation signal and a reference signal, and receive a correction signal through a first correction terminal and to adjust a duty cycle of a corresponding one of the control signals according to the correction signal. The correction conversion circuit is configured to generate a correction signal according to an error current. The error current represents a difference between a current threshold value and a corresponding output current for the corresponding phase.

### CROSS-REFERENCE TO RELATED APPLICATION

This application claims priority to Taiwan Application Serial Number 112151458, filed Dec. 28, 2023, which is herein incorporated by reference in its entirety.

### BACKGROUND

### Technical Field

The present disclosure relates to current balancing technology, specifically a current balancing circuit and a multi-phase voltage regulator circuit.

### Description of Related Art

A power converter (such as a DC-to-DC converter) is an electromechanical device for conversion of electric energy, and is configured to convert the voltage of a DC power supply. Power converters are extensively applied to low-power devices (e.g., batteries) or high-power devices (e.g., industrial machines). A multi-phase power converter comprises multiple converters corresponding to different phases to output power to the output terminal in turn. Whether the output power between the converters corresponding to different phases is consistent will affect the power supply stability of the power converter. Therefore, it requires a new power converter to provide better power supply stability.

### SUMMARY

One aspect of the present disclosure is a multi-phase voltage regulator circuit, applied to a multi-phase power converter, comprising a plurality of comparison circuits. The plurality of comparison circuits is coupled to a power output stage circuit of the multi-phase power converter, and is configured to generate a plurality of control signals. The power output stage circuit generates a plurality of output currents according to the plurality of control signals. One of the plurality of comparison circuits comprises a comparator and a correction conversion circuit. The comparator is configured to receive a compensation signal and a reference signal, and is configured to receive a correction signal through a first correction terminal of the comparator and to adjust a duty cycle of a corresponding one of the plurality of control signals according to the correction signal. The correction conversion circuit is coupled to the comparator, and is configured to generate the correction signal according to an error current. The error current represents a difference between a current threshold value and a corresponding one of the plurality of output currents.

Another aspect of the present disclosure is a current balancing circuit, applied to a multi-phase power converter, comprising a current detection circuit and a comparison circuit. The current detection circuit is coupled to a power output stage circuit of the multi-phase power converter to receive a plurality of output currents, and is configured to calculate an average current of the plurality of output currents. The comparison circuit is coupled to the current detection circuit, and is configured to compare a compensation signal and a reference signal to output a control signal. The power output stage circuit is configured to adjust a first output current of the plurality of output currents according to the control signal. The comparison circuit is configured to use a difference between the average current and the first output current as a correction signal, and is configured to adjust a duty cycle of the control signal according to the correction signal.

Accordingly, by generating a correction signal according to the error current and inputting the correction signal to the correction terminal of the comparator, the duty cycle of the control signal can be adjusted in real time to achieve the purpose of controlling the currents corresponding to different phases to be equal. In addition, since the present disclosure does not compensate signals, there is no need to use complex circuits or change the operation of the multi-phase power converter, and can be easily applied and implemented.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a multi-phase power converter in some embodiments of the present disclosure.

FIG. 2 is a schematic diagram of a current detection circuit in some embodiments of the present disclosure.

FIG. 3A is a schematic diagram of a comparison circuit in some embodiments of the present disclosure.

FIG. 3B is a schematic diagram of a comparison circuit in some embodiments of the present disclosure.

FIG. 3C is a waveform diagram of a control signal in some embodiments of the present disclosure.

FIG. 4A is a schematic diagram of a comparison circuit in some embodiments of the present disclosure.

FIG. 4B is a schematic diagram of a comparison circuit in some embodiments of the present disclosure.

FIG. 5A is a schematic diagram of a comparison circuit in some embodiments of the present disclosure.

FIG. 5B is a schematic diagram of a comparison circuit in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” comprises an associated listed items or any and all combinations of more.

The present disclosure relates to a multi-phase power converter, for example a multi-phase power converter, which is used to convert an input voltage to output output voltages with different voltage levels. In one embodiment, the multi-phase power converter is used in vehicle power supply, for example, as a power transmission circuit to store power from a charging pile into a battery, or to provide power stored in a battery to in-vehicle devices. However, the present disclosure is not limited thereto. In other embodiments, the multi-phase power converter can also be applied to other devices and loads.

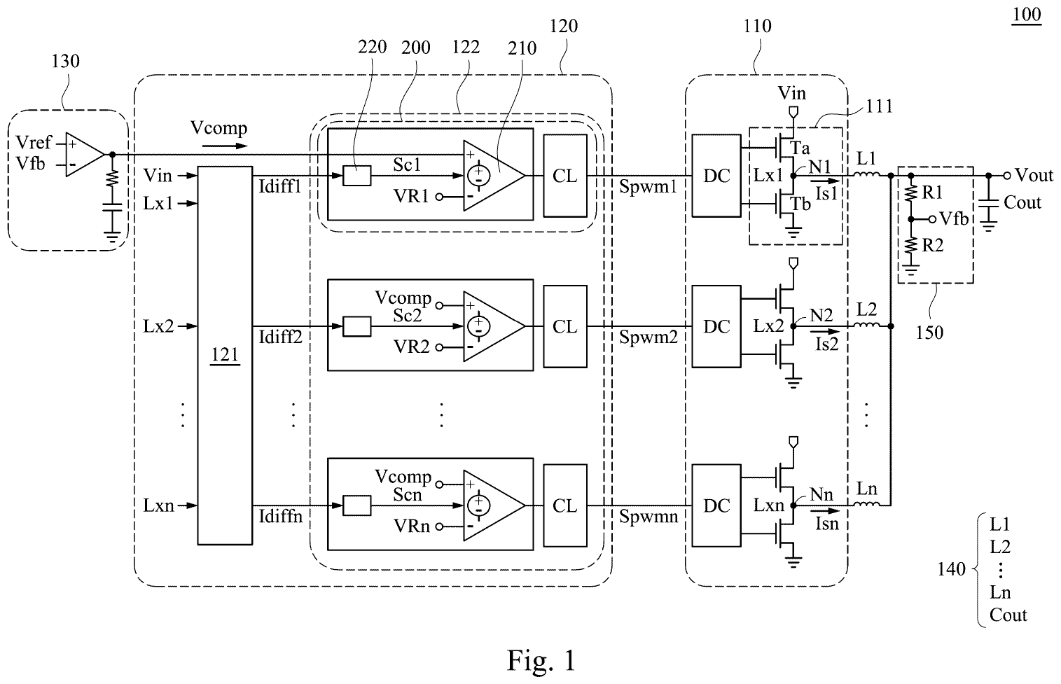

FIG. 1 is a schematic diagram of a multi-phase power converter in some embodiments of the present disclosure. In the embodiment of FIG. 1, the multi-phase power converter is implemented as a multi-phase power converter 100. The multi-phase power converter 100 comprises a power output stage circuit 110, a current balancing circuit 120 and a compensation circuit 130. The power output stage circuit 110 comprises multiple driving circuits DC and switching circuits 111 formed by multiple transistor switches. One driving circuit DC and the corresponding switching circuit 111 are configured to generate the corresponding one of output currents Is1˜Isn according to the input voltage Vin.

In the embodiment shown in FIG. 1, the power output stage circuit 110 comprises multiple subcircuits (e.g., two or more). Each subcircuit comprises a driving circuit DC and a switching circuit 111. In each subcircuit, the switching circuit 111 comprises a high-side bridge switch Ta and a low-side bridge switch Tb, and is coupled to an input voltage Vin. The driving circuits DC are configured to control the respective high-side bridge switches Ta and the respective low-side bridge switches Tb to be turned on or off according to the received control signals to generate or adjust the corresponding output currents Is1˜Isn. The output currents Is1˜Isn generated by the subcircuits correspond to different phases. For example, there is a corresponding phase difference between the output currents Is1˜Isn of the subcircuits.

In one embodiment, the power output stage circuit 110 generates an output voltage Vout and a feedback voltage Vfb by an energy storage circuit 140 and a voltage divider circuit 150. The energy storage circuit 140 is coupled to the power output stage circuit 110, and comprises multiple inductors L1˜Ln and an output capacitor Cout. The voltage divider circuit 150 comprises multiple voltage dividing resistors R1, R2. Since people in the art can understand method of generating the output voltage Vout by the power output stage circuit 110, so it will not be described here.

The current balancing circuit 120 is coupled to the power output stage circuit 110, and comprises multiple comparison circuits 200, the comparison circuits 200 are configured to generate control signals Spwm1˜Spwmn of the output currents Is1˜Isn corresponding to different phases, so as to provide the control signals Spwm1˜Spwmn to the corresponding driving circuits DC respectively. The method for generating the control signals will be detailed in the subsequent paragraphs.

The compensation circuits 130 are respectively coupled to the current balancing circuit 120 and the voltage divider circuit 150, so as to receive the feedback voltage Vfb from the voltage divider circuit 150. In one embodiment, the feedback voltage Vfb is a voltage value which is obtained through dividing the the output voltage Vout of the output terminal by the voltage dividing resistors R1 and R2. The compensation circuit 130 is further configured to compare the feedback voltage Vfb with a reference voltage Vref to generate a compensation signal Vcomp according to a difference between the feedback voltage Vfb and the reference voltage Vref. The reference voltage Vref can be a fixed voltage value, therefore, the compensation signal Vcomp is configured to represent a current status of the output voltage Vout (e.g., heavy load or light load). The compensation signal Vcomp is provided to the current balancing circuit 120, and the current balancing circuit 120 generates the control signals Spwm1˜Spwmn according to the compensation signal Vcomp and provides the control signals Spwm1˜Spwmn to the driving circuits DC respectively.

As mentioned above, in one embodiment, a positive terminal of the compensation circuit 130 is configured to receive the reference voltage Vref, and a negative terminal of the compensation circuit 130 is configured to receive the feedback voltage Vfb. Therefore, the intensity of the compensation signal Vcomp is positively related to “a difference between the reference voltage Vref and the feedback voltage Vfb”, however, the present disclosure is not limited thereto. In other embodiments, the signals received by the positive and negative terminals of the compensation circuit 130 can be interchanged according to the actual circuit design.

In one embodiment of the present disclosure, the current balancing circuit 120 is provided with multiple comparison circuits 200 to adjust the control signals Spwm1˜Spwmn provided to the power output stage circuit 110 in real time according to the power supply status (e.g., according to the compensation signal Vcomp and/or the output current) of the multi-phase power converter 100. Accordingly, it will be ensured that the currents corresponding to different phases output by the multi-phase power converter 100 are maintained in balance (i.e., the output currents corresponding to the phases can be maintained substantially equal).

For ease of explanation, the multiple comparison circuits 200 in the multi-phase power converter 100 are collectively referred to as a multi-phase voltage regulator circuit 122. The multi-phase voltage regulator circuit 122 is configured to generate and adjust multiple control signals Spwm1˜Spwmn corresponding to different phases, so that the power output stage circuit 110 generates multiple output currents Is1˜Isn corresponding to different phases according to the control signals Spwm1˜Spwmn, thereby keeping the currents corresponding to different phases balanced.

In some embodiments, the control signals Spwm1˜Spwmn generated by comparison circuits 200 are pulse width modulation (PWM) signals, and the control signals Spwm1˜Spwmn are provided to the driving circuits DC through multiple logic circuits CL. In addition, the comparison circuits 200 can further adjust the duty cycles of the respective control signals Spwm1˜Spwmn, thereby changing the intensity of the output currents Is1˜Isn generated by the power output stage circuit 110. Since people in the art can understand method of transmitting the control signals using digital signals by the logic circuits CL and the driving circuits DC, it will not be described here.

In some embodiments, each of reference signals VR1˜VRn can be a periodic signal, the intensity of which changes periodically within a signal cycle. In some other embodiments, each of the reference signals VR1˜VRn can be a sawtooth wave with a fixed slope in signal cycles. The “sawtooth wave” starts to change (e.g., rise or fall) from an initial fixed level within each signal cycle, and returns to the initial fixed level at the end of the current signal cycle and the beginning of the next signal cycle. In some embodiments, the sawtooth wave has a positive slope in one single. That is, in one signal cycle, a level of the sawtooth wave rises gradually. Whereas, the present disclosure is not limited hereto because each of the reference signals VR1˜VRn may be a triangular wave based on different slopes for the change in the level of the reference signal in other embodiments. In addition, the phases of the reference signals VR1˜VRn are different to generate the control signals Spwm1˜Spwmn with different phases.

The following explains the method by which the comparison circuit 200 generates the control signals Spwm1˜Spwmn. As shown in FIG. 1, in one embodiment, each comparison circuit 200 is coupled between the compensation circuit 130 and the power output stage circuit 110, and comprises a comparator 210. Multiple input terminals of the comparator 210 are configured to receive the compensation signal Vcomp and a corresponding one of the reference signals VR1˜VRn respectively, so that the comparison circuit 200 generates one of the control signals Spwm1˜Spwmn according to a relative relationship between the compensation signal Vcomp and the corresponding reference signal. The output of the comparator 210 is converted into a control signal (e.g., one of the control signals Spwm1˜Spwmn) by the corresponding logic circuit CL, and the control signal is transmitted to the power output stage circuit 110. However, in some embodiments of the present disclosure, the logic circuits CL may be omitted. In one embodiment, for each of the comparators 210, a positive input terminal of the comparator 210 is configured to receive the compensation signal Vcomp, and a negative input terminal thereof is configured to receive the corresponding reference signal (one of the reference signals VR1˜VRn, such as the reference signal VR1 shown in FIG. 1), but the present disclosure is not limited to this.

Specifically, when the compensation signal Vcomp is greater than the corresponding reference signal, the comparison circuit 200 adjusts the corresponding control signal to a high level. When the compensation signal Vcomp is less than the corresponding reference signal, the comparison circuit 200 adjusts the corresponding control signal to a low level. Since the compensation signal Vcomp represents the status of the output voltage Vout, when the compensation signal Vcomp changes, the comparison circuit 200 can adjust the duty cycle of the corresponding control signal in real time, change the output current, and thereby change the output voltage Vout.

For example, when the output voltage Vout is too great, the feedback voltage Vfb is also increased, so that the difference between the reference voltage Vref and the feedback voltage Vfb becomes smaller, which causes the compensation signal Vcomp to be decreased.

As mentioned above, each of the comparison circuits 200 is configured to compare the compensation signal Vcomp and the corresponding reference signal (i.e., the corresponding one of the reference signals VR1 to VRn) to generate the corresponding one of the control signals Spwm1˜Spwmn, and then adjust the corresponding output current. However, since the compensation signal Vcomp only represents an overall load level of the multi-phase power converter 100 but does not represent “a difference between output currents corresponding to different phases”, each of the comparators 210 of the comparison circuit 200 in this embodiment further receives a corresponding one of correction signals Sc1˜Scn through a correction terminal, and adjusts/corrects the duty cycle of the corresponding generated control signal generated according to the corresponding one of the correction signal Sc1˜Scn.

The correction signals Sc1˜Scn are generated according to multiple error currents Idiff1˜Idiffn, and each of the error currents Idiff1˜Idiffn is a difference between a corresponding one of the output currents Is1˜Isn and a current threshold value. For example, the control signal Spwm1 generated by one comparison circuit 200 is configured to cause the power output stage circuit 110 to generate the output current Is1 corresponding to a first phase. A difference between the output current Is1 corresponding to the first phase and a specific current threshold value serves as the error current Idiff1. The error currents Idiff1˜Idiffn can be directly used as the correction signals Sc1˜Scn, or can be used as the correction signals Sc1˜Scn after conversion.

In one embodiment, the current threshold value can be a preset fixed current value, such as an ideal value of the output current when the multi-phase power converter 100 is operating normally. In another embodiment, the current threshold value may be an average value or a median value of multiple drive currents generated by the power output stage circuit 110, but the present disclosure is not limited thereto. In some variations of the present disclosure, the current threshold value may be a default value, or may be obtained by looking up a table.

The present disclosure does not directly change the signals received by the comparison circuit 200 (i.e., the compensation signal Vcomp and the corresponding one of the reference signals VR1˜VRn), but receives a corresponding one of the correction signals Sc1˜Scn through the correction terminal other than input terminals (the positive input terminal and the negative input terminal) of the comparison circuit 200, thereby affecting the comparison result of the comparison circuit 200 to change the duty cycle of the corresponding control signal.

In one embodiment, each of the comparators 210 uses the corresponding one of the correction signals Sc1˜Scn as an offset voltage and compares the compensation signal Vcomp and the corresponding reference signal according to the offset voltage. The offset voltage can be regarded as a reference standard for the signal comparison performed by the comparator 210. Therefore, when the one of the correction signals Sc1˜Scn induces a offset voltage on the corresponding correction terminal, it will indirectly affect a comparison result of the comparator 210 (i.e., changing the duty cycle of the control signal). In other words, the comparator 210 adjusts the duty cycle of the corresponding control signal according to the corresponding offset voltage. The method of generating the correction signals Sc1˜Scn will be described in detail in subsequent paragraphs.

In one embodiment, the current balancing circuit 120 further comprises a current detection circuit 121. The current detection circuit 121 is coupled to the power output stage circuit 110 to obtain the output currents Is1˜Isn generated by the power output stage circuit 110, and is configured to calculate the current threshold value according to the output currents Is1˜Isn. In another embodiment, the current detection circuit 121 can detect multiple phase nodes N1˜Nn between the high-side bridge switches Ta and the low-side bridge switches Tb in the power output stage circuit 110, so as to obtain voltages Lx1˜Lxn of phase nodes N1˜Nn, and then calculate the corresponding output currents. Moreover, the current detection circuit 121 can further calculate an average of the output currents as the current threshold value. The current detection circuit 121 can directly output the current threshold value and a corresponding output current of the corresponding phase to the corresponding comparison circuit 200, or output a corresponding error current of the corresponding phase to the corresponding comparison circuit 200 after calculating the error currents Idiff1˜Idiffn.

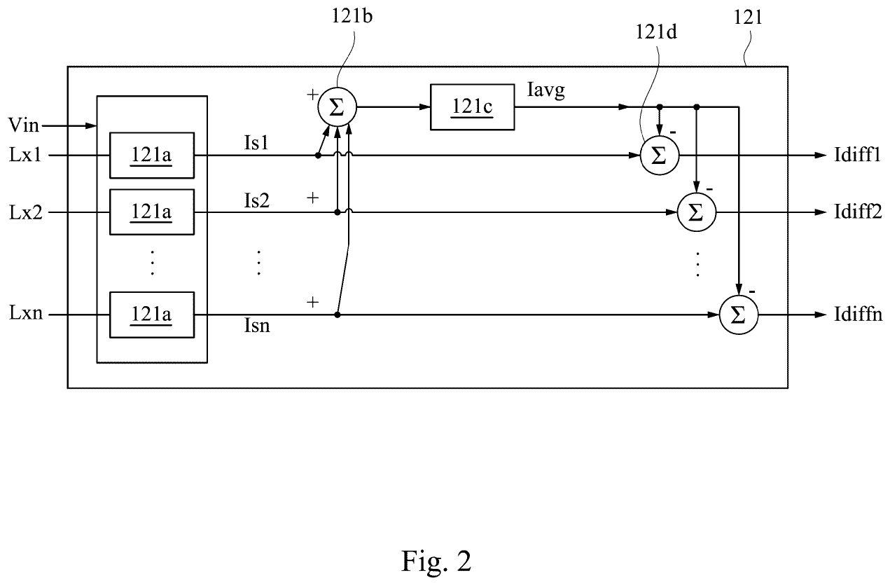

FIG. 2 is a schematic diagram of the current detection circuit 121 in some embodiments of the present disclosure. As shown in FIG. 1 and FIG. 2, the current detection circuit 121 comprises multiple transconductance circuits 121a, an adder circuit 121b, a divider circuit 121c and multiple subtractor circuits 121d. The transconductance circuits 121a are coupled to the power output stage circuit 110 to receive the output currents Is1˜Isn. In one embodiment, the transconductance circuits 121a comprise respective transconductance amplifiers, so as to receive voltages of the phase nodes N1˜Nn, and then calculate the output currents Is1˜Isn.

The adder circuit 121b is coupled to the transconductance circuits 121a, and is configured to receive the output currents Is1˜Isn. An average current Iavg of the output currents Is1˜Isn is calculated by the adder circuit 121b and the divider circuit 121c. The subtractor circuits 121d are coupled to the divider circuit 121c. Each of the subtractor circuits 121d is configured to calculate a difference between the corresponding output current of the corresponding phase and the average current Iavg to generate a corresponding one of the error currents Idiff1 ˜Idiffn.

In one embodiment, each of the comparison circuits 200 further comprises a correction conversion circuit 220. The correction conversion circuits 220 are coupled between the current detection circuit 121 and the respective comparators 210. Each of the correction conversion circuits 220 is coupled to the comparator 210, and is configured to provide/generate a correction signal to the correction terminal of the corresponding comparator 210 according to the corresponding one of the error currents Idiff1˜Idiffn, so that the corresponding comparator 210 adjusts the duty cycle of the corresponding control signal according to the correction signal. Specifically, each of the correction conversion circuits 220 is configured to receive a corresponding one of the error currents Idiff1˜Idiffn from the current detection circuit 121. Each of the correction conversion circuits 220 is configured to directly use the corresponding error current as the correction signal, or convert the corresponding error current into a voltage signal or current signal and then provide the voltage signal or current signal to the correction terminal of the corresponding comparator 210 as the correction signal.

In another embodiment, each of the correction conversion circuits 220 can receive the current threshold value and the corresponding output current from the current detection circuit 121, and then calculate/generate the corresponding correction signal. For example, the correction conversion circuit 220 converts the current threshold value and the corresponding output current into a voltage signal or a current signal, and provides the voltage signal or current signal as the correction signal that is provided to the correction terminal of the corresponding comparator 210.

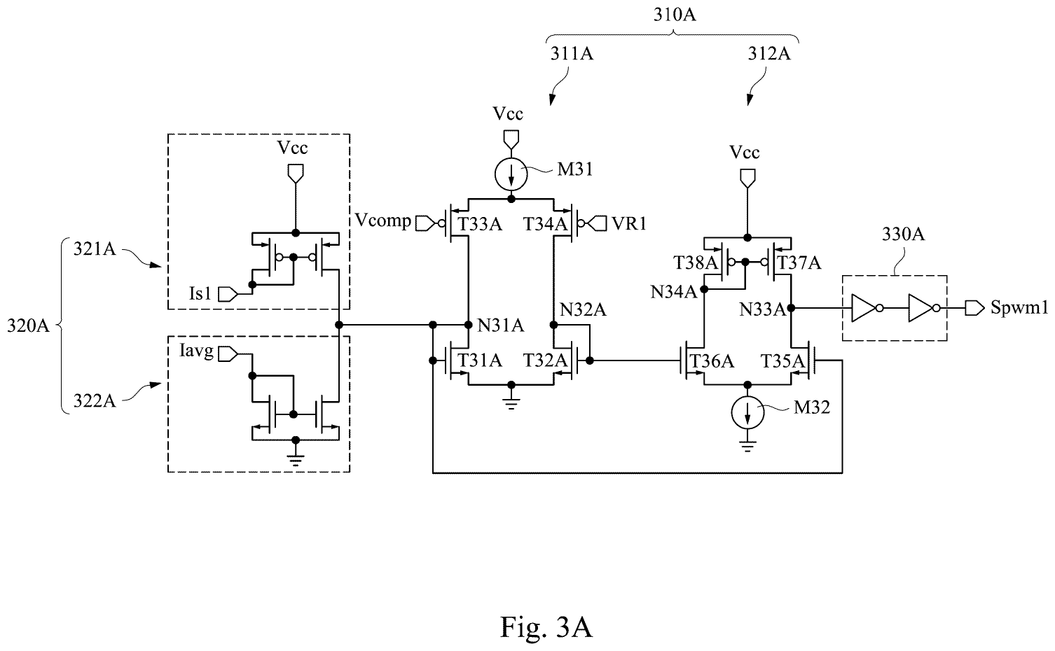

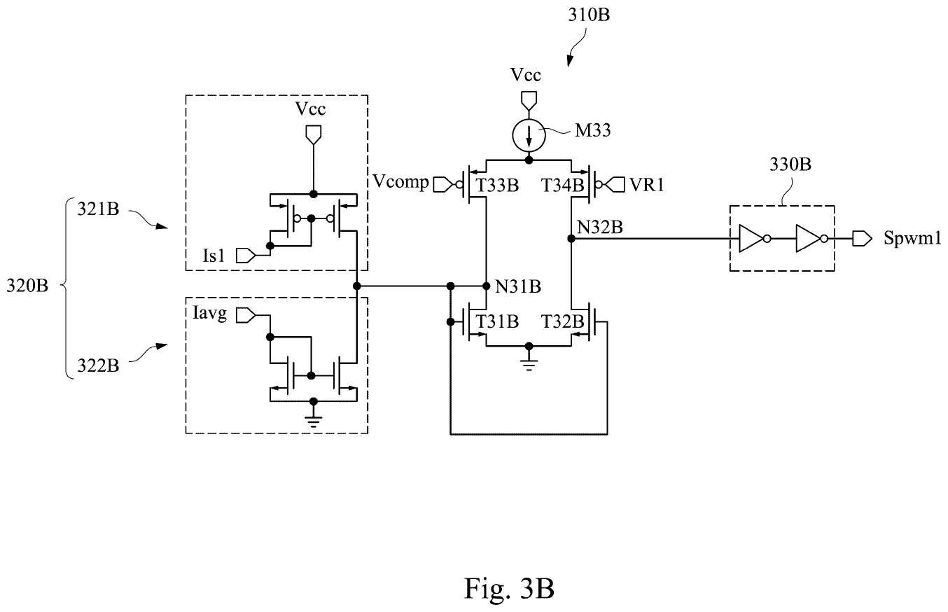

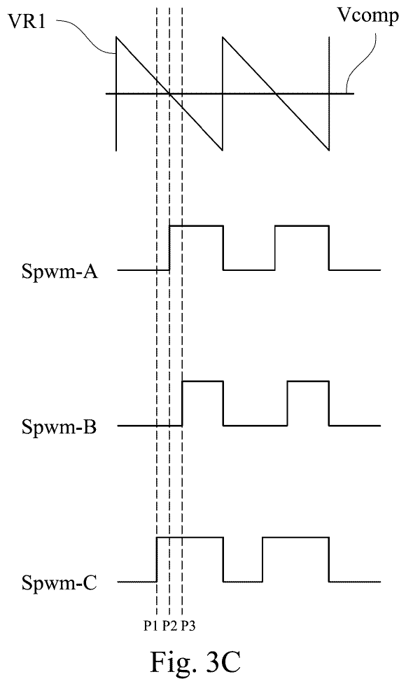

Each of the correction conversion circuits 220 inputs the error current/the correction signal to the correction terminal of the corresponding comparator 210 to induce the offset voltage, so that the comparator 210 can compare the compensation signal Vcomp and the corresponding one of the reference signals VR1˜VRn according to the offset voltage. Specifically, each of the correction conversion circuits 220 may comprise a current mirror to transmit the corresponding one of the error currents Idiff1˜Idiffn to the corresponding comparator 210. In other embodiments, each of the correction conversion circuits 220 further comprises a transconductance amplifier for a voltage-to-current conversion, or comprises a transimpedance amplifier or a current amplifier for a current-to-voltage conversion. Specific embodiments of the correction conversion circuits 220 will be introduced in FIGS. 3A, 3B, 4A, 4B, 5A, and 5B.

For ease of understanding, the operation of the comparison circuit is explained here according to the embodiment disclosed in FIG. 3A. FIG. 3A is a schematic diagram of a comparison circuit in some embodiments of the present disclosure, which can be applied to the multi-phase power converter 100 shown in FIG. 1. The comparison circuit shown in FIG. 3A can be an example of the comparison circuit 200 shown in FIG. 1, and a comparator 310A and a correction circuit 320A can respectively be an example of the comparator 210 and the correction conversion circuit 220 shown in FIG. 1. Two input terminals of the comparator 310A are configured to receive the compensation signal Vcomp and the reference signal (taking VR1 as an example here), and compare the compensation signal Vcomp and the reference signal VR1 according to an offset voltage formed by an error current. In addition, the comparator 310A further has multiple nodes N31A˜N34A, wherein a voltage level of the node N31A can be an example of the offset voltage mentioned above.

In this embodiment, the comparator 310A is a two-stage comparator, including a first stage comparator 311A and a second stage comparator 312A. The first stage comparator 311A and the second stage comparator 312A are respectively coupled to the power supply Vcc, and have two current sources M31 and M32 and multiple transistors T31A˜T38A. Taking the first stage comparator 311A as an example, a control terminal of the transistor T31A is coupled to the node N31A, which use as a correction terminal. The transistors T33A and T34A are coupled to the current source M31. However, the comparator 310A is not limited to the two-stage comparator. In other embodiments, the comparator 310A can also be implemented as a single-stage comparator.

The correction circuit 320A comprises a first correction circuit 321A and a second correction circuit 322A. The first correction circuit 321A and the second correction circuit 322A respectively comprise current mirrors (but the present disclosure is not limited thereto), are respectively configured to receive the first output current Is1 and the average current Iavg (e.g., through the current detection circuit 121 and the correction conversion circuit 220 shown in FIG. 1), and generate the same currents as the first output current Is1 and the average current Iavg at the node N31A. In an embodiment, the average current Iavg can be changed to a fixed current threshold value instead of real-time calculation. The first correction circuit 321A and the second correction circuit 322A are coupled to the same correction terminal of the comparator 310A. Therefore, the current value of the node N31A will depend on a relative relationship between the first output current Is1 and the average current Iavg (i.e., the error current or the correction signal mentioned above).

The correction circuit 320A is configured to adjust the duty cycle of the corresponding one of the control signals (such as the control signals Spwm1˜Spwmn shown in FIG. 1), so that the output current of the corresponding phase can be consistent with the output currents of the other phases. Referring to FIGS. 1, 3A and 3C, FIG. 3C shows the following waveforms from top to bottom: a waveform comprising the compensation signal Vcomp and the reference signal VR1, a waveform Spwm-A corresponds to the control signal Spwm1 when “the first output current Is1 is equal to the average current Iavg”, a waveform Spwm-B corresponds to the control signal Spwm1 when “the first output current Is1 is greater than the average current Iavg”, and a waveform Spwm-C corresponds to the control signal Spwm1 when “the first output current Is1 is less than the average current Iavg”.

As shown in FIG. 1, for example, in a positive half cycle of the control signal Spwm1, when the control signal Spwm1 has a high level (e.g., a signal “1”) and the reference signal VR1 is less than the compensation signal Vcomp, the high-side bridge switch Ta is turned on and the low-side bridge switch Tb is turned off, the input voltage Vin charges the output capacitor Cout and the inductor L1, which forms the output current Is1 flowing from the phase node N1 to the output capacitor Cout. Then, the current detection circuit 121 receives the voltages Lx1˜Lxn of the phase nodes N1˜Nn, and calculates the output currents Is1˜Isn according to the voltages Lx1˜Lxn respectively. As shown in FIG. 1 and FIG. 2, the current detection circuit 121 respectively compares each of the output currents Is1˜Isn with an average value of the output currents Is1˜Isn (i.e., the average current Iavg, or with the aforementioned current threshold value). If the first output current Is1 is equal to the average current Iavg, then as a time point P2 shown in FIG. 3C, a time point when the control signal Spwm1 changes to the high level will be the same as a time point when the compensation signal Vcomp is equal to the reference signal VR1.

When the detected first output current Is1 is greater than the average current Iavg, the correction circuit 320A will be decreased the duty cycle of the control signal Spwm1 to decrease the first output current Is1, so that the first output current Is1 remains equal to the other output currents Is2˜Isn corresponding to the other phases, as shown in the waveform Spwm-B in FIG. 3C. On the other hand, when the detected first output current Is1 is less than the average current Iavg, the correction circuit 320A increases the duty cycle of the control signal Spwm1 to increase the first output current Is1, so that the first output current Is1 remains equal to the other output currents Is2˜Isn corresponding to the other phases, as shown in the waveform Spwm-C in FIG. 3C.

As shown in FIG. 3A, when the first output current Is1 is greater than the average current Iavg, a current will flow from the node N31A to the transistor T35A, so the voltage of the node N31A will be gradually increased. Therefore, the control terminal of the transistor T35A has the high level and is turned on. A current path from the node N33A to the ground through the current source M32 will be formed, causing a level of the node N33A to be quickly pulled down to a low level (e.g., a signal “0”). Therefore, the control signal Spwm1 is pulled down, which is equivalent to delaying a time when the control signal Spwm1 enters the high level, that is, decreasing the duty cycle of the control signal Spwm1. As a time point P3 shown in FIG. 3C, the control signal Spwm1 will be delayed to enter the high level at the time point P3 instead of entering the high level at the time point P2. In addition, because currents flowing through the nodes N31A and N32A compete with each other for the current from the current source M31, when the node N31A has the high level, the node N32A has the low level and the transistor T32A is turned off. At this time, the node N34A has the high level, and the transistors T37A and T38A are turned off.

Please note that the buffer circuit 330A is an example of the logic circuit CL in FIG. 1, which can comprise but is not limited to two inverters connected in series. The buffer circuit 330A is configured to provide a digital signal, which has the same logic level as the level of the node N33A, as the control signal Spwm1. In some embodiments, if the buffer circuit 330A is coupled to the node N34A instead of the node N33A, the buffer circuit 330A must be designed to comprise only one single inverter to ensure that a phase of the output signal (i.e., the control signal Spwm1) is correct For another example, if the first correction circuit 321A and the second correction circuit 322A are changed to receive the average current Iavg and the first output current Is1 respectively, then the buffer circuit 330A must be designed to comprise only one single inverter to ensure that a phase of the output signal (i.e., the control signal Spwm1) is correct.

In addition, the control signal Spwm1 generated by the buffer circuit 330A has better signal thrust. However, in some embodiments of the present disclosure, the buffer circuit 330A may be omitted. Through the correction circuit 320A of the present disclosure, when the first output current Is1 is greater than the average current Iavg, the node N33A quickly enters the low level, which results in that the time when the control signal Spwm1 enters the high level is delayed (refer to FIG. 3C, the control signal Spwm1 is delayed to enter the high level at the time point P3 instead of the time point P2), so as to decrease the duty cycle of the control signal Spwm1, thereby decreasing the output current (e.g., the first output current Is1) output by the switching circuit 111, thereby achieving the purpose of equalizing multiple currents corresponding to different phases.

On the other hand, when the first output current Is1 is less than the average current Iavg, the current will flow from the node N31A to the correction circuit 320A, so the voltage of the node N31A has the low level. Therefore, the control terminal of the transistor T35A has the low level and is not turned on. In addition, because the currents flowing through the nodes N31A and N32A compete with each other (i.e., when the current flowing to one of them is increased, the current flowing to the other one is decreased), when the node N31A has the low level, the node N32A has the high level and the transistors T32A and T36A are turned on. At this time, a level of the node N34A is pulled down by the ground through the current source M32 and has the low level, causing the transistor T37A and T38A to be turned on. Therefore, the node N33A is pulled to the high level in advance, which is equivalent to causing the control signal Spwm1 to enter the high level in advance (as shown in FIG. 3C, at this time, the control signal Spwm1 enters the high level at a time point P1 in advance, instead of entering the high level at the time point P2), causing the duty cycle of the control signal Spwm1 to be increased.

In other words, through the correction circuit 320A of the present disclosure, when the first output current Is1 is less than the average current Iavg, the node N33A quickly enters the high level to increase the duty cycle of the control signal Spwm1 provided to the driving circuit DC, thereby increasing the intensity of the output current (e.g., the first output current Is1) generated by the switching circuit 111, which achieves the purpose of equalizing multiple currents corresponding to different phases.

According to the above content, the present disclosure does not adjust the signals received by the two input terminals of the comparator 310A (or the comparator 210). That is, the compensation signal or the reference signal received by the comparator is not adjusted, but the duty cycle of the control signal is adjusted through the correction terminal (e.g., the node N31A) according to the difference between the output current (e.g., the first output current Is1) of the corresponding phase and the average current Iavg. Accordingly, the output currents corresponding to different phases output by the power output stage circuit 110 are increased or decreased to achieve the effect of equalizing the output currents corresponding to different phases output by the power output stage circuit 110. Please note that the operations of FIGS. 3A, 3B, 4A, 4B, 5A and 5B can be illustrated with the positive half cycle of the control signal Spwm1 shown in FIG. 3C.

FIG. 3B is a schematic diagram of a comparison circuit in some embodiments of the present disclosure. The difference between FIG. 3B and FIG. 3A is that the comparator 310B is a single-stage comparator. The comparison circuit comprises a comparator 310B, a correction circuit 320B and a buffer circuit 330B, and the correction circuit 320B comprises a first correction circuit 321B and a second correction circuit 322B. Similar to FIG. 3A, the comparator 310B is coupled to the power supply Vcc, and comprises a current source M33 and multiple transistors T31B˜T34B.

The correction circuit 320B is configured to adjust the duty cycle of the control signal Spwm1, so that the output current of the corresponding phase can be consistent with the output currents corresponding to the other phases. Therefore, when the detected first output current Is1 is greater than the average current Iavg, the correction circuit 320B decreases the duty cycle of the control signal Spwm1 to decrease the first output current Is1, so that the first output current Is1 remains equal to the other output currents Is2˜Isn corresponding to the other phases. On the other hand, when the detected first output current Is1 is lower than the average current Iavg, the correction circuit 320B increases the duty cycle of the control signal Spwm1 to increase the first output current Is1, so that the first output current Is1 remains equal to the other output currents Is2˜Isn corresponding to the other phases.

As shown in FIG. 3B, when the first output current Is1 is greater than the average current Iavg, a current will flow from a node N31B to the transistor T32B. At this time, the voltage of the node N31B is increased, so that the control terminal of the transistor T32B has a high level (e.g., a signal “1”) and is turned on. A voltage level of the node N31B can be an example of the offset voltage mentioned above.

Since the transistor T32B is turned on, a node N32B is pulled down quickly, so that the time when the control signal Spwm1 enters the high level is delayed (refer to FIG. 3C, the control signal Spwm1 enters the high level at the time point P3 instead of the time point P2). Accordingly, the duty cycle of the control signal Spwm1 is decreased, so that the first output current Is1 output by the driving circuit DC is decreased accordingly, which achieves the purpose of controlling the current corresponding to different phases to be equal.

The correction circuit 320B in FIG. 3B can be the same as the correction circuit 320A in FIG. 3A, and the buffer circuit 330B in FIG. 3B can be the same as 330A in FIG. 3A. Please note that the buffer circuit 330B may comprise two inverters connected in series, but the present disclosure is not limited thereto. For example, in some embodiments, if the buffer circuit 330B is changed to coupled to the node N31B instead of the node N32B, the buffer circuit 330B must be designed to comprise only one single inverter to ensure that a phase of the output signal (i.e., the control signal Spwm1) is correct. For another example, if the first correction circuit 321B and the second correction circuit 322B are changed to receive the average current Iavg and the first output current Is1 respectively, the buffer circuit 330B must be designed to comprise only one single inverter to ensure that a phase of the output signal (i.e., the control signal Spwm1) is correct.

On the other hand, when the first output current Is1 is less than the average current Iavg, the current will flow from the node N31B to the correction circuit 320B, so the voltage of the node N31B has a low level (e.g., a signal “0”). Therefore, the control terminal of the transistor T32B has the low level and is not turned on. At this time, the node N32B will be increased to the high level in advance, which advances the time when the control signal Spwm1 enters the high level (refer to FIG. 3C, the control signal Spwm1 enters the high level at the time point P1 in advance instead of the time point P2), so that the duty cycle of the control signal Spwm1 is increased. In other words, through using the error current/correction signal/offset voltage, the node N32B enters the high level faster, and the time period of the control signal Spwm1 is at the high level becomes longer, which will increase the duty cycle of the control signal Spwm1. Accordingly, the first output current Is1 is increased, which can also achieve the purpose of equalizing multiple currents corresponding to different phases.

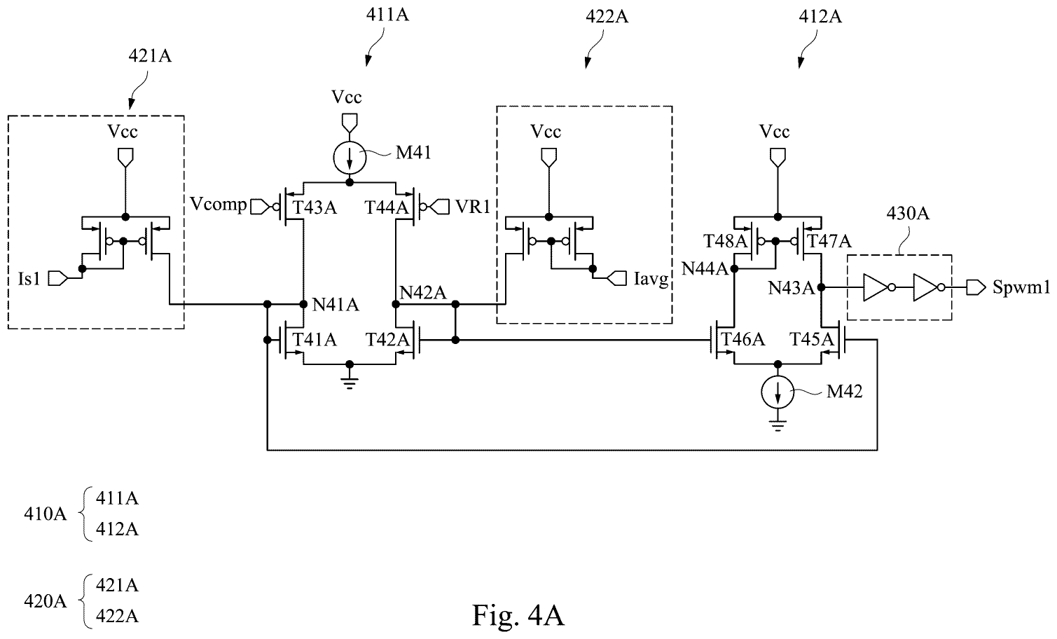

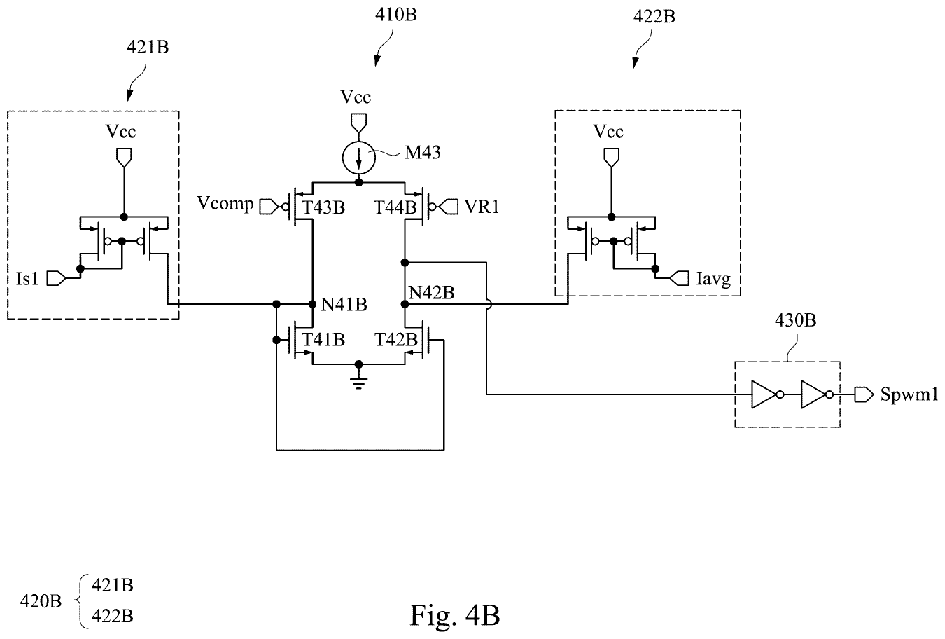

FIG. 4A is a schematic diagram of a comparison circuit in some embodiments of the present disclosure, which can be applied to the multi-phase power converter 100 shown in FIG. 1. The comparison circuit comprises a comparator 410A, a correction circuit 420A and a buffer circuit 430A. Two input terminals of the comparator 410A are respectively configured to receive the compensation signal Vcomp and the reference signal VR1, and the comparator 410A further comprises multiple nodes N41A˜N44A. A voltage level of the node N41A can be an example of the offset voltage mentioned above. The comparison circuit shown in FIG. 4A can be an example of the comparison circuit 200 shown in FIG. 1, and the comparator 410A and the correction circuit 420A of the comparison circuit can respectively be an example of the correction conversion circuit 220 shown in FIG. 1.

In this embodiment, the comparator 410A can be a two-stage comparator, comprises a first stage comparator 411A and a second stage comparator 412A. The comparator 410A may be the same as the comparator 310A shown in FIG. 3A and comprise multiple transistors T41A˜T48A and multiple current sources M41 and M42, however, the present disclosure is not limited thereto. In other embodiments, the comparator 410A may also be implemented as a single-stage comparator.

The correction circuit 420A comprises a first correction circuit 421A and a second correction circuit 422A. The first correction circuit 421A and the second correction circuit 422A respectively comprises current mirrors, and are respectively coupled to different correction terminals (e.g., nodes N41A and N42A) of the comparator 410A. The correction circuit 420A receives a first output current Is1 and an average current Iavg by the first correction circuit 421A and the second correction circuit 422A, that is the correction circuit 420A obtains an error current between the first output current Is1 and the average current Iavg.

Specifically, the first correction circuit 421A is coupled to one (i.e., the node N41A) of the correction terminals of the comparator 410A, and is configured to input the first output current Is1 to the node N41A as a first correction signal. The second correction circuit 422A is coupled to the other one (i.e., the node N42A) of the correction terminals of the comparator 410A, and is configured to input the current threshold value (e.g., the average current Iavg) to the node N42A as a second correction signal. Accordingly, the comparator 410A compares the compensation signal Vcomp with the reference signal VR1 according to offset voltages formed by the first correction signal and the second correction signal.

The correction circuit 420A is configured to adjust the duty cycle of the control signal Spwm1, so that the output current of the corresponding phase can be consistent with the output currents corresponding to the other phases. When the detected first output current Is1 is greater than the average current Iavg, the correction circuit 420A decreases the duty cycle of the control signal Spwm1 to decrease the first output current Is1, so that the first output current Is1 is consistent with the other output currents Is2˜Isn corresponding to the other phases. On the other hand, when the detected first output current Is1 is less than the average current Iavg, the correction circuit 420A increases the duty cycle of the control signal Spwm1 to increase the first output current Is1, so that the first output current Is1 is consistent with the other output currents Is2˜Isn corresponding to other phases.

As shown in FIG. 4A, when the first output current Is1 and the average current Iavg are input to the nodes N41A and N42A respectively and the first output current Is1 is greater than the average current Iavg, the node N41A has a high level (e.g., a signal “1”), so the transistor T45A is turned on, which forms a current path from the node N43A to the ground through the current source M42.

Therefore, a level of the node N43A is pulled down, which is equivalent to delaying the time when the control signal Spwm1 enters the high level (refer to FIG. 3C, the control signal Spwm1 is delayed to enter the high level at the time point P3 instead of the time point P2). Furthermore, because the currents flowing through the nodes N41A and N42A compete with each other for the current from the current source M41, when the node N41A has the high level, the node N42A has a low level (e.g., a signal “0”), and the transistor T46A is turned off. At this time, the node N44A has the high level, and the transistors T47A and T48A are turned off. In other words, a level of the node N43A is pulled down by the error current/correction signal/offset voltage pulls down to decrease the duty cycle of the control signal Spwm1. Then, the intensity of the output current (e.g., the first output current Is1) output by the switching circuit 111 is decreased, thereby achieving the purpose of equalizing multiple currents corresponding to different phases.

On the other hand, when the first output current Is1 and the average current Iavg are input to the nodes N41A and N42A respectively, and the first output current Is1 is less than the average current Iavg, the voltage of the node

N41A has the low level, so that the control terminal of the transistor T45A has the low level and the transistor T45A is not turned on. In addition, because the currents flowing from the current source M41 to the nodes N41A and N42A are in a competitive relationship, when the node N41A is the low level, the node N42A has the high level, causing the transistor T42A and T46A to be turned on. At this time, the level of the node N44A is pulled down by the ground through the current source M41 and then has the low level, so that the transistor T47A and T48A are turned on. Therefore, the node N43A is pulled up to the high level in advance, which is equivalent to the control signal Spwm1 entering the high level in advance (refer to FIG. 3C, the control signal Spwm1 enters the high level at the time point P1 in advance instead of the time point P2), causing the duty cycle of the control signal Spwm1 to be increased.

It should be noted that the buffer circuit 430A may comprise two inverters connected in series, but the present disclosure is not limited thereto. For example, in some embodiments, if the buffer circuit 430A is changed to be coupled to the node N44A instead of the node N43A, the buffer circuit 430A must be designed to comprise only one single inverter to ensure that a phase of the output signal (i.e., the control signal Spwm1) is correct. For another example, if the first correction circuit 421A and the second correction circuit 422A are changed to receive the average current Iavg and the first output current Is1 respectively, the buffer circuit 430A must be designed to comprise only one single inverter to ensure that a phase of the output signal (i.e., the control signal Spwm1) is correct.

FIG. 4B is a schematic diagram of a comparison circuit in some embodiments of the present disclosure. The difference between FIG. 4B and FIG. 4A is that the comparator 410B is a single-stage comparator. The correction circuit 420B comprises a first correction circuit 421B and a second correction circuit 422B. Similar to FIG. 4A, the comparator 410B is coupled to the power supply Vcc and comprises has a current source M43 and multiple transistors T41B˜T44B.

The correction circuit 420B is configured to adjust the duty cycle of the control signal Spwm1, so that the output current of the corresponding phase is consistent with the output currents corresponding to the other phases. Therefore, when the detected first output current Is1 is greater than the average current Iavg, the correction circuit 420B decreases the duty cycle of the control signal Spwm1 to decrease the first output current Is1, so that the first output current Is1 remains equal to the other output currents Is2˜Isn corresponding to the other phases. On the other hand, when the detected first output current Is1 is less than the average current Iavg, the correction circuit 420B increases the duty cycle of the control signal Spwm1 to increase the first output current Is1, so that the first output current Is1 remains equal to the other output currents Is2˜Isn corresponding to the other phases.

As shown in FIG. 4B, when the first output current Is1 and the average current Iavg are input to two nodes N41B and N42B and the first output current Is1 is greater than the average current Iavg, the node N41B has a high level (e.g., a signal “1”) to turn on the transistor T42B (the voltage level of the node N41B can be an example of the offset voltage mentioned above). Therefore, a level of node

N42B is pulled down, which is equivalent to delaying the time when the control signal Spwm1 enters the high level (refer to FIG. 3C, the control signal Spwm1 is delayed to enter the high level at the time point P3 instead of the time point P2). That is, the duty cycle of the control signal Spwm1 is decreased, which causes the first output current Is1 to be decreased accordingly, thereby achieving the purpose of controlling the current corresponding to different phases to be equal.

Similarly, when the first output current Is1 and the average current Iavg are input to the nodes N41B and N42B and the first output current Is1 is less than the average current Iavg, the voltage of the node N42B enters the high level fast, that is, the control signal Spwm1 enters the high level in advance, so that the duty cycle of the control signal Spwm1 is increased, which causes the first output current Is1 to be increased accordingly, thereby achieving the purpose of controlling the current corresponding to different phases to be equal.

It should be noted that the buffer circuit 430B may comprise two inverters connected in series, but the present disclosure is not limited thereto. For example, in some embodiments, if the buffer circuit 430B is changed to be coupled to the node N41B instead of the node N42B, the buffer circuit 430B must be designed to comprise only one single inverter to ensure that a phase of the output signal (i.e., the control signal Spwm1) is correct. For another example, if the first correction circuit 421B and the second correction circuit 422B are changed to receive the average current Iavg and the first output current Is1 respectively, the buffer circuit 430B must be designed to comprise only one single inverter to ensure that a phase of the output signal (i.e., the control signal Spwm1) is correct.

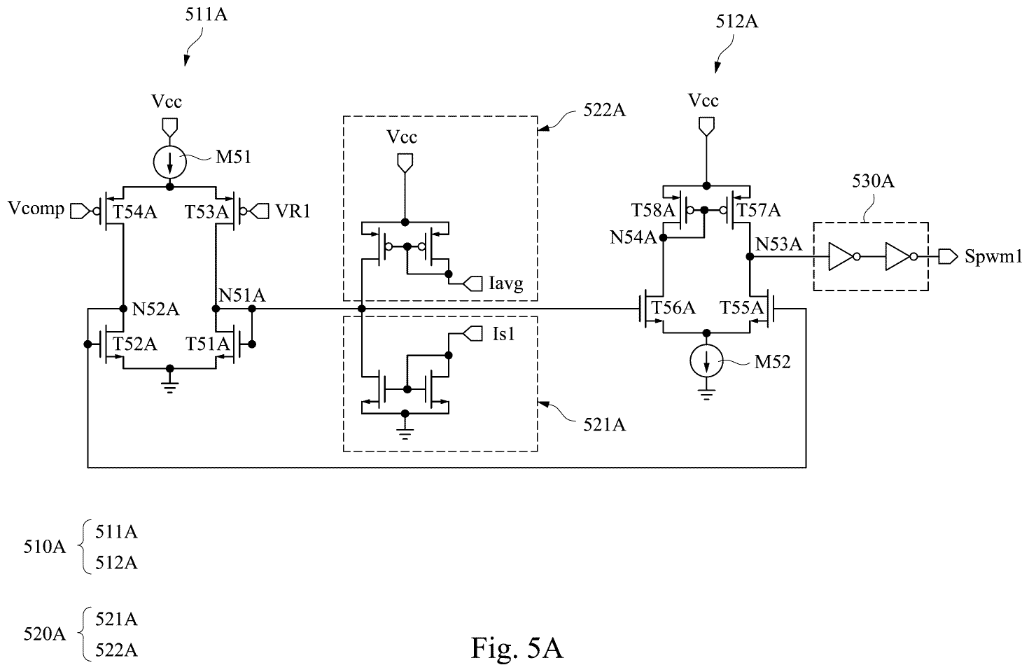

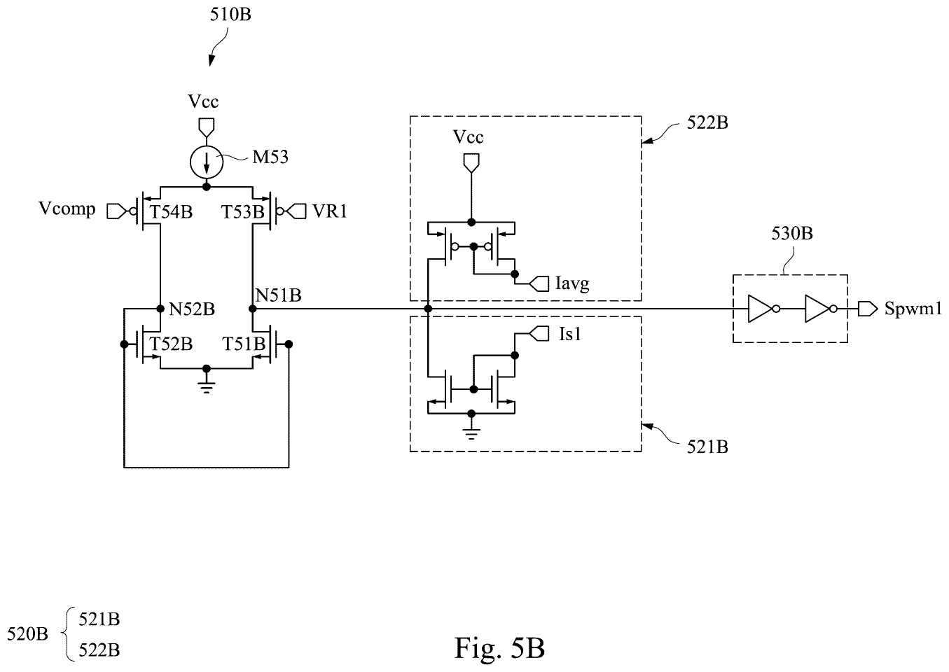

FIG. 5A is a schematic diagram of a comparison circuit in some embodiments of the present disclosure, which can be applied to the multi-phase power converter 100 shown in FIG. 1. The comparison circuit comprises a comparator 510A, a correction circuit 520A and a buffer circuit 530A. The comparison circuit shown in FIG. 5A can be an example of the comparison circuit 200 shown in FIG. 1, and the comparator 510A and the correction circuit 520A can be examples of the comparator 210 and the correction conversion circuit 220 shown in FIG. 1, respectively. Two input terminals of the comparator 510A are configured to receive the compensation signal Vcomp and the reference signal VR1 respectively, and further comprises multiple nodes N51A˜N54A.

In this embodiments, the comparator 510A is a two-stage comparator, comprises a first stage comparator 511A and a second stage comparator 512A. The comparator 510A may be the same as the comparator 310A shown in FIG. 3A and comprise multiple transistors T51A˜T58A and current sources M51 and M52, however, the present disclosure is not limited thereto. In other embodiments, the comparator 510A may also be implemented as a single-stage comparator.

The correction circuit 520A comprises a first correction circuit 521A and a second correction circuit 522A. The first correction circuit 521A and the second correction circuit 522A may respectively comprise current mirrors (but the present disclosure is not limited thereto), and are respectively configured to receive the first output current Is1 and the average current Iavg. The average current Iavg can be replaced with a fixed current threshold value. The first correction circuit 521A and the second correction circuit 522A are coupled to the same one (e.g., the node N51A) of two correction terminals of the comparator 510A. Therefore, a current value of the node N51A will depend on “a relative relationship between the average current Iavg and the first output current Is1” (i.e., the error current or the correction signal mentioned above).

As shown in FIG. 5A, when the first output current Is1 is greater than the average current Iavg, a current will flow from the node N51A to the correction circuit 520A, so that a voltage level of the node N51A will be gradually decreased, and the voltage of the node N52A will be gradually increased (the voltage level of the node N52A can be an example of the offset voltage mentioned above). Therefore, the control terminal of the transistor T55A is turned on with a high level (e.g., a signal “1”) of the control terminal. At this time, the node N53A is pulled down through the current source M52, which is equivalent to delaying the time when the control signal Spwm1 enters the high level (refer to FIG. 3C, the control signal Spwm1 is delayed to enter the high level at the time point P3 instead of the time point P2), that is, decreasing the duty cycle of the control signal Spwm1 when the control signal Spwm1 is 1 (or when the control signal Spwm1 is at a high level). As a result, the first output current Is1 is decreased, thereby achieving the purpose of controlling the currents corresponding to different phases to be equal. In addition, when the node N51A has a low level (e.g., a signal “0”), the transistor T56A is turned off. At this time, the node N54A is at a high level, and the transistor T57A and T58A are turned off.

On the other hand, when the first output current Is1 is less than the average current Iavg, a current will flow from the correction circuit 520A to the node N51A. Since currents flowing from the current source M51 to the node

N51A and N52A are in a competitive relationship, the voltage of the node N51A will be gradually increased, and the voltage of the node N52A will be gradually decreased, so that the control terminal of the transistor T51A has the low level and is turned off. In addition, when the node N51A has the high level, the transistor T56A is turned on. At this time, the node N54A is pulled down to the low level by the current source M52, so that the transistor T57A and T58A are turned on. Therefore, the node N53A is at a high level to advance the time when the control signal Spwm1 enters the high level (refer to FIG. 3C, the control signal Spwm1 enters the high level at the time point P1 in advance instead of the time point P2). That is, the duty cycle of the control signal Spwm1 is increased, so that the first output current Is1 is increased accordingly, thereby achieving the purpose of controlling the currents corresponding to different phases to be equal.

It should be noted that the buffer circuit 530A may comprise two inverters connected in series, but the present disclosure is not limited thereto. For example, in some embodiments, if the buffer circuit 530A is changed to be coupled to the node N54A instead of being coupled to the node N53A, the buffer circuit 530A must be designed to comprise only one single inverter to ensure that a phase of the output signal (i.e., the control signal Spwm1) is correct. For another example, if the first correction circuit 521A and the second correction circuit 522A are changed to receive the average current Iavg and the first output current Is1 respectively, the buffer circuit 530A must be designed to comprise only one single inverter to ensure that a phase of the output signal (i.e., the control signal Spwm1) is correct.

FIG. 5B is a schematic diagram of a comparison circuit in some embodiments of the present disclosure. The difference between FIG. 5B and FIG. 5A is that the comparator 510B is a single-stage comparator. The comparison circuit comprises a comparator 510B, a correction circuit 520B and a buffer circuit 530B, and the correction circuit 520B comprises a first correction circuit 521B and a second correction circuit 522B. Similar to FIG. 5A, the comparator 510B is coupled to the power supply Vcc and comprises a current source M53 and multiple transistors T51B˜T54B.

As shown in FIG. 5B, when the first output current Is1 is greater than the average current Iavg, a current will flow from a node N51B to the correction circuit 520B, wherein a voltage level of a node N51B can be an example of the offset voltage mentioned above. At this time, since the currents flowing from the current source to the nodes N51B and N52B are in a competitive relationship, the voltage level of the node N51B will be gradually decreased, the voltage of the node N52B will be gradually increased. Accordingly, the control signal Spwm1 is pulled down to the low level, which is equivalent to delaying the time when the control signal Spwm1 enters the high level (refer to FIG. 3C, the control signal Spwm1 is delayed to enter the high level at the time point P3 instead of the time point P2), that is, decreasing the duty cycle of the control signal Spwm1. As a result, the first output current Is1 is decreased, thereby achieving the purpose of controlling the currents corresponding to different phases to be equal.

On the other hand, when the first output current Is1 is less than the average current Iavg, a current will flow from the correction circuit 520B to the node N51B, so that the voltage level of the node N51B will be gradually increased, and the voltage of the node N52B will be gradually decreased. Therefore, the time when the control signal Spwm1 enters the high level in advance (refer to FIG. 3C, the control signal Spwm1 enters the high level at the time point P1 in advance instead of the time point P2). That is, the duty cycle of the control signal Spwm1 is increased, so that the first output current Is1 is also increased, thereby achieving the purpose of controlling the currents corresponding to different phases to be equal.

It should be noted that the buffer circuit 530B may comprise two inverters connected in series, but the present disclosure is not limited thereto. For example, in some embodiments, if the buffer circuit 530B is changed to be coupled to the node N52B, instead of being coupled to the node N51B, the buffer circuit 530B must be designed to comprise only one single inverter to ensure that a phase of the output signal (i.e., the control signal Spwm1) is correct. For another example, if the first correction circuit 521B and the second correction circuit 522B are changed to receive the average current Iavg and the first output current Is1 respectively, the buffer circuit 530B must be designed to comprise only one single inverter to ensure that a phase of the output signal (i.e., the control signal Spwm1) is correct.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A multi-phase voltage regulator circuit, applied to a multi-phase power converter, comprising:
a plurality of comparison circuits, coupled to a power output stage circuit of the multi-phase power converter, and configured to generate a plurality of control signals,
wherein the power output stage circuit generates a plurality of output currents according to the plurality of control signals, and
wherein one of the plurality of comparison circuits comprises:
a comparator, wherein the comparator is configured to receive a compensation signal and a reference signal, and is configured to receive a correction signal through a first correction terminal of the comparator and to adjust a duty cycle of a corresponding one of the plurality of control signals according to the correction signal; and
a correction conversion circuit, coupled to the comparator, and configured to generate the correction signal according to an error current, wherein the error current represents a difference between a current threshold value and a corresponding one of the plurality of output currents.

2. The multi-phase voltage regulator circuit of claim 1, wherein the compensation signal is a difference between a feedback voltage provided by a output terminal of the multi-phase power converter and a reference voltage.

3. The multi-phase voltage regulator circuit of claim 1, wherein the correction signal is configured to form an offset voltage at the first correction terminal, and the comparator adjust the duty cycle of the corresponding one of the plurality of control signals according to the offset voltage.

4. The multi-phase voltage regulator circuit of claim 3, wherein the multi-phase power further comprises:
a current detection circuit, coupled to the power output stage circuit, and configured to receive the plurality of output currents to calculate the current threshold value.

5. The multi-phase voltage regulator circuit of claim 4, wherein the current threshold value is an average value of the plurality of output currents.

6. The multi-phase voltage regulator circuit of claim 3, wherein the correction conversion circuit further comprises:
a first correction circuit, coupled to the first correction terminal of the comparator, and configured to input the corresponding one of the plurality of output currents to the first correction terminal as a first correction signal; and
a second correction circuit, coupled to a second correction terminal of the comparator, and configured to input the current threshold value to the second correction terminal as a second correction signal;
wherein the comparator is configured to compare the compensation signal and the reference signal according to a plurality of offset voltages formed by the first correction signal and the second correction signal.

7. The multi-phase voltage regulator circuit of claim 1, wherein the correction conversion circuit is further coupled to a current detection circuit of the multi-phase power converter, and is configured to receive the current threshold value and the corresponding one of the plurality of output currents, or receive the error current; and
wherein the correction conversion circuit is configured to convert the current threshold and the corresponding one of the plurality of output currents into a voltage signal or a current signal, or to convert the error current into a voltage signal or a current signal.

8. The multi-phase voltage regulator circuit of claim 7, wherein the correction conversion circuit comprises a transconductance amplifier, a transimpedance amplifier or a current amplifier.

9. The multi-phase voltage regulator circuit of claim 1, wherein the reference signal is a periodic signal.

10. The multi-phase voltage regulator circuit of claim 1, wherein a waveform of the reference signal has a fixed slope within a signal cycle.

11. A current balancing circuit, applied to a multi-phase power converter, comprising:
a current detection circuit, coupled to a power output stage circuit of the multi-phase power converter to receive a plurality of output currents, and configured to calculate an average current of the plurality of output currents; and
a comparison circuit, coupled to the current detection circuit, and configured to compare a compensation signal and a reference signal to output a control signal, wherein the power output stage circuit is configured to adjust a first output current of the plurality of output currents according to the control signal;
wherein the comparison circuit is configured to use a difference between the average current and the first output current as a correction signal, and is configured to adjust a duty cycle of the control signal according to the correction signal.

12. The current balancing circuit of claim 11, wherein the compensation signal is a difference between a feedback voltage provided by a output terminal of the multi-phase power converter and a reference voltage.

13. The current balancing circuit of claim 11, wherein the comparison circuit comprises a comparator, the comparator is configured to receive the compensation signal and the reference signal, and receives the correction signal formed by the average current and the first output current through a first correction terminal, so as to form an offset voltage at the first correction terminal.

14. The current balancing circuit of claim 13, wherein the comparison circuit further comprises:
a first correction circuit, coupled to the first correction terminal of the comparator, and configured to input the first output current to the first correction terminal as a first correction signal; and
a second correction circuit, coupled to a second correction terminal of the comparator, and configured to input the average current to the second correction terminal as a second correction signal;
wherein the comparator is configured to compare the compensation signal and the reference signal according to a plurality of offset voltages formed by the first correction signal and the second correction signal.

15. The current balancing circuit of claim 11, wherein the comparison circuit further comprises:
a correction conversion circuit, coupled to the current detection circuit to receive the average current and the first output current, or receive a error current between the average current and the first output current;
wherein the correction conversion circuit is configured to convert the average current and the first output current into a voltage signal or a current signal, or to convert the error current into a voltage signal or a current signal.

16. The current balancing circuit of claim 15, wherein the correction conversion circuit comprises a transconductance amplifier, a transimpedance amplifier or a current amplifier.

17. The current balancing circuit of claim 11, wherein the reference signal is a periodic signal.

18. The current balancing circuit of claim 17, wherein a waveform of the reference signal has a fixed slope within a signal cycle.
